(19) United States
(12) Patent Application Publication
(10) Pub. No.: US 2006/0006123 A1
(43) Pub. Date: Jan. 12, 2006

(54) METHOD OF REGENERATING FILTER MEDIA IN A FILTER

(76) Inventors: WEN-TA HUANG, Miao- Li Hsien (TW); CHEN-HUNG HSIEN, Miao- Li Hsien (TW)

Correspondence Address: NORTH AMERICA INTELLECTUAL PROPERTY CORPORATION, P.O. BOX 506, MERRIFIELD, VA, 22116, US

(21) Appl. No.: 10/710,370

(22) Filed: Jul. 6, 2004

(51) Int. Cl. B01D 24/46

(52) U.S. Cl. 210/791

(57) ABSTRACT

First, water in a filter is drained to a low level, and the remaining water is adjusted to an alkaline condition so as to break up the flocs in the filter media. Then, a pneumatic rinsing process is performed, by introducing air from the bottom of the filter for shaking the filter media, so as to loosen the flocs. After that, a reverse rinsing process is performed, by providing water from the bottom of the filter, so that small flocs, having a relatively small specific gravity, float up to be removed. Finally, a sterilizing process is performed upon the filter media, and the impurities remaining in the filter media are cleaned up to ensure the quality of water to be filtered.

### BACKGROUND OF INVENTION

1. Field of the Invention

The present invention relates to a method of regenerating filter media, and more particularly, to a method of regenerating filter media in a filter.

2. Description of the Prior Art

In a common water supply system, tap water is processed in order to fulfill the requirements of civil use water. Nevertheless, the tap water still contains some tiny particles having a size of approximately 1 micrometer. These particles, normally composed of glues, are usually suspended in the tap water, and therefore are not easily removed. These suspended particles are acceptable for civil use water, however, the suspended particles may cause some unexpected influence when the tap water is provided for industrial purposes. For example, for chemical processes or biochemical processes which require highly purified water, these particles are not acceptable. Therefore, tap water for industrial use has to be further processed so as to remove these suspended particles and improve the purity.

Please refer to FIG. 1, which is a schematic diagram of a water pre-processing system 10. As shown in FIG. 1, crude water is supplied to a gelation tank 12, and a proper amount of flocculant 14 is added to flocculate the particles contained in the crude water. Normally, the flocculant 14 is made of poly aluminum chloride (PAC), and has a pH value between 6.5 and 7. PAC forms aluminum complex ions (Al₈(OH)₂₀⁴⁺) in the water, and neutralizes with the suspended particles (mostly with negative charges) so as to flocculate the suspended particles. In addition, the flocculant 14 also includes polymer substances, which work to assemble the neutralized particles together by a cross-linking effect. The assembled particles form small flocs, and by gently agitating the water solution these small flocs grow into large flocs for the convenience of separation.

When the suspended particles in the gelation tank 12 form larger flocs due to electrical neutralization and the cross-linking effect, the tap water is then dispensed to a filter 18, such as a gravity type filter or a pressure type filter, through a dispenser 16. The filter 18 includes filter media 20, which are stacks of several different materials, such as anthracites, quartz sands, pebbles, etc., of different sizes. Accordingly, the flocs, which are larger than the gap of the filter 20, will remain in the filter 20 when the tap water is passed through. The tap water will then be delivered to a storage tank 22 for further use.

In the filter 18, the flocs continuously accumulate (particularly when the quality of crude water is poor or when the flocculant 14 added in the tap water is not precisely controlled), and will eventually clog the gaps of the filter media 20. This increases the pressure differences between the opposite sides of the filter 20, and therefore reduces the amount of the tap water flowing from the filter 18 to the storage tank 22. Once the quantity of flow is reduced to an extent, the water pre-processing system 10 must be shut down for performing a filter media regeneration process to improve the pressure differences in the filter 18 until the quantity of flow is recovered.

Please refer to FIG. 2 and FIG. 3. FIG. 2 is a flowchart illustrating a conventional filter media regeneration procedure 30, and FIG. 3 is a schematic diagram of a filter 18. As shown in FIG. 2 and FIG. 3, the filter media regeneration process begins by performing a draining process 32 to discharge the water from a water outlet 52 until the water level reaches the top surface of the filter media 20. Then a pneumatic rinsing process 34 is performed, by introducing air from an air inlet 54 positioned in the bottom of the filter 18, to agitate the filter media 20 so that the flocs are broken up, loosened, and are not tightly adhered to the filter media 20. A reverse rinsing process 36 then follows, by providing water from a water inlet 56a positioned under the filter media 20, to shake the filter media 20. Accordingly, the small flocs, having a relatively smaller specific gravity, will float up and discharge through a water outlet 56b positioned above the filter media 20. Finally, a cleaning process 38 is performed, by providing water from a water inlet 58a, to discharge the particles remaining in the filter media 20 with water through a water outlet 58b.

However, after the conventional filter media regeneration procedure is performed, many flocs are frequently found remaining inside the filter media. When the flocs are not completely removed during the filter media regeneration procedure, the remaining flocs will combine with new flocs to form mud balls having a large diameter in a later filtering process. Under this condition, the mud balls cannot be broken up by air, nor can they be separated in the reverse rinsing process. If the flocs or mud balls are not removed in the media filter regeneration procedure, the pressure difference between the opposite sides of the filter media cannot be reduced. This results in a poor water yield.

Once the above condition occurs, the filter media cannot be used and has to be renewed. This seriously reduces the lifetime of the filter media, and thus a new method of regenerating filter media is required.

### SUMMARY OF INVENTION

It is therefore a primary object of the present invention to provide a method of regenerating filter media to solve the aforementioned problems.

According to a preferred embodiment of the present invention, a method of regenerating filter media is provided to remove flocs remaining in the filter media, reduce the pressure difference across the filter media, and further increase the water yield. The method includes the following steps. First, water in the filter is drained to a low level, and the remaining water is adjusted to an alkaline condition so as to break up the flocs in the filter media. Then, a pneumatic rinsing process is performed, by introducing air from the bottom of the filter for shaking the filter media, so as to loosen the flocs. After that, a reverse rinsing process is performed, by providing water from the bottom of the filter, so that small flocs, having a relatively small specific gravity, float up to be removed. Finally, a sterilizing process is performed upon the filter media, and the impurities remaining in the filter media are cleaned up to ensure the quality of water to be filtered.

The method according to the present invention alters the types of aluminum ions in the filter media by adjusting the pH value so that the flocculation ability of the flocs is substantially reduced. Since the flocs remaining in the filter media after the filter media regeneration procedure is decreased, the effect of the filter media regeneration procedure is greatly improved, and the lifetime of the media is extended.

These and other objectives of the present invention will no doubt become obvious to those of ordinary skill in the art after having read the following detailed description of the preferred embodiment that is illustrated in the various figures and drawings.

### BRIEF DESCRIPTION OF DRAWINGS

FIG. 1 is a schematic diagram of a conventional water pre-processing system.

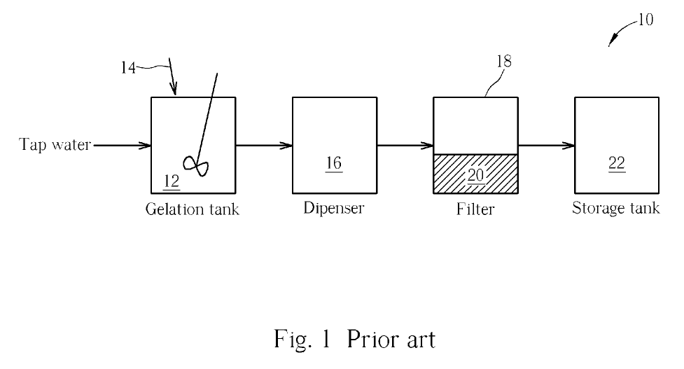

FIG. 2 is a flowchart illustrating a conventional filter media regeneration procedure.

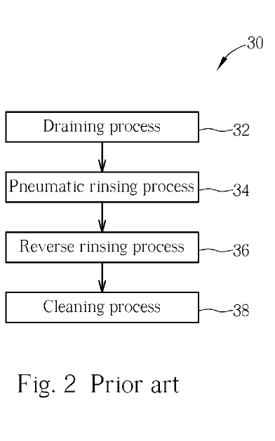

FIG. 3 is a schematic diagram of a conventional filter.

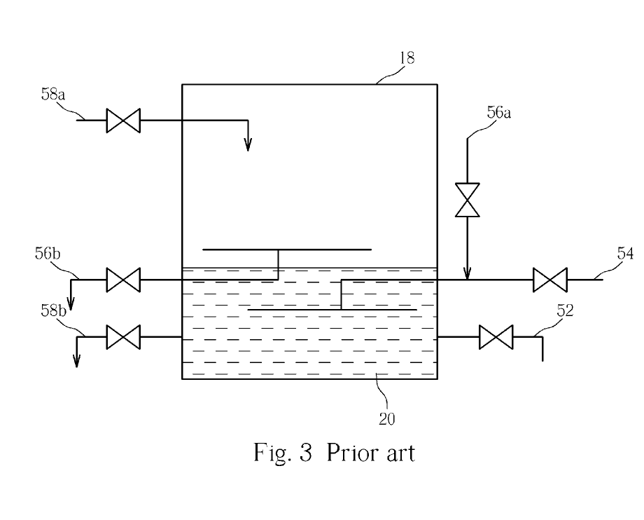

FIG. 4 is a flowchart illustrating a method of filter media regeneration according to a preferred embodiment of the present invention.

FIG. 5 is a schematic diagram of a filter of the present invention.

FIG. 6 is a table illustrating the types of aluminum for different pH values.

### DETAILED DESCRIPTION

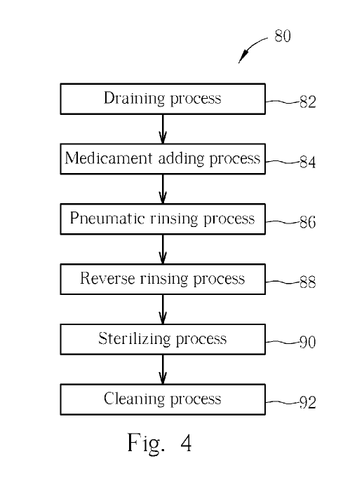

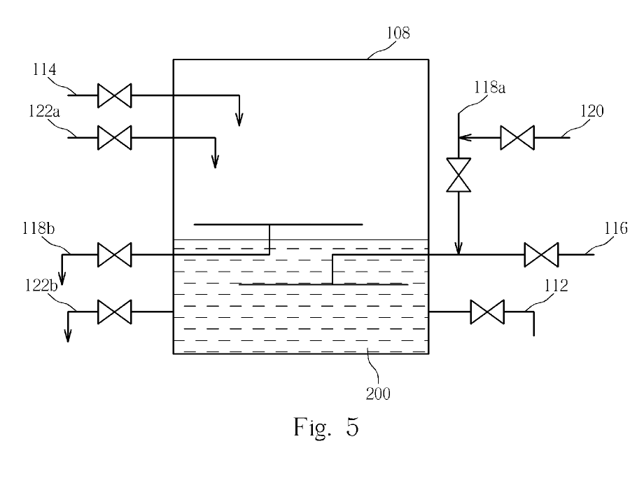

Please refer to FIG. 4 and FIG. 5. FIG. 4 is a flowchart illustrating a filter media regeneration procedure 80 according to a preferred embodiment of the present invention. FIG. 5 is a schematic diagram of a filter 108 of the present invention. As shown in FIG. 4 and FIG. 5, a draining process 82 is performed to drain water in the filter 108 through a water outlet 112 to a low water level. In this embodiment, the water level is controlled, such as by a level gage, to a level about 50 cm over a filter media 200 to reduce the required amount of medicament to be added.

A medicament adding process 84 is then performed to add a proper amount of alkali medicament through a medicament inlet 114 positioned above the filter 108 to adjust the water solution in the filter 108 to an alkali condition, such that the aluminum ions of the flocs are altered into different types. In this embodiment, the amount of alkali medicament, such as sodium hydroxide (NaOH) or potassium hydroxide (KOH), is quantitatively determined by the water level of the filter 108, so as to maintain the pH value of the solution in the filter 108 between 9 to 10. Accordingly, the aluminum of the flocs will form aluminum complex ions with negative charges (Al(OH₄)⁻), and decompose the flocs.

A pneumatic rinsing process 86 is then performed to introduce air through an air inlet 116 so as to shake the filter media 200, and further break up the flocs. A reverse rinsing process 88 follows to provide water through a water inlet 118a for floating a portion of the filter media 200. In the reverse rinsing process 88, some small flocs float up due to a relatively smaller specific gravity, and discharge through a water outlet 118b. In this embodiment, the water outlet 118b is positioned about 50 cm over the filter media 200 for the sake of saving water and avoiding loss of filter media 200.

A sterilizing process 90 is then performed to implant a sterilant through a medicament inlet 120 into the filter 108. In this embodiment, the sterilizing process 90 is performed along with the reverse rinsing process 118, and sodium hypochlorite (NaOCl) is selected as the sterilant. It is noted that the sterilizing effect of sodium hypochlorite (NaOCl) is poor in an alkaline condition, and thus sodium hypochlorite (NaOCl) is not implanted until the reverse rinsing process 88 is performed to a certain extent. Finally, a cleaning process 92 is performed, by providing water through a water inlet 122a into the filter 108, to clean up the filter media 200. In the cleaning process 92, the impurities remaining in the filter media 200 are discharged with water through a water outlet 122b, such that the quality of water in ensured. It is also to be noted that the sterilizing process 92 is selectively performed where necessary. For example, the sterilizing process 92 can be carried out periodically (such as once a month), or according to the quality of the tap water.

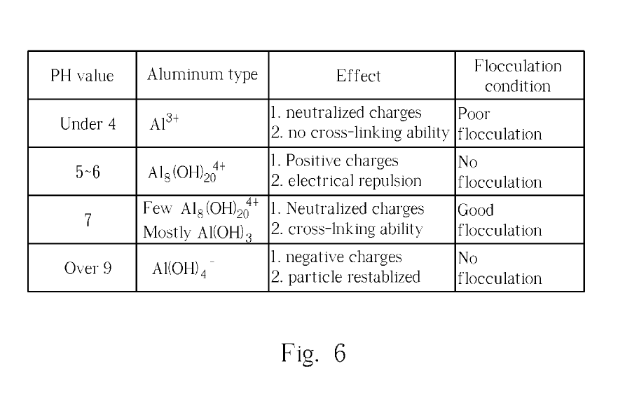

Please refer to FIG. 6, which is a table illustrating types of aluminum for different pH values. As shown in FIG. 6, since the method of regenerating filter media according to the present invention adjusts the solution in the filter to an alkaline condition by adding alkali medicament, the aluminum of the flocculant exists in the form of (Al(OH₄)⁻) with negative charge, rather than (Al₈(OH)₂₀⁴⁺) which exists in a neutral condition. For the suspended particles with negative charges, consequently, the flocculation ability is substantially diminished, which reduces the strength of the flocs. In such a case, large flocs can be simply broken into small flocs in the pneumatic rinsing process or in the reverse rinsing process, and then be separated due to their relatively small specific gravity. In other words, the amount of flocs remaining in the filter media is substantially reduced, and therefore the effect of the filter media regeneration procedure is effectively improved.

In comparison with the prior art, the method of regenerating filter media is characterized by adding alkali medicament into the filter to reduce the strength of the flocs. Consequently, large flocs are broken into small flocs in the pneumatic rinsing process, and are not tightly adhered to the filter media. In such a case, the small flocs can be separated from the filter media in the reverse rinsing process by taking advantage of specific gravity differences. Therefore, the effect of the filter media regeneration procedure is improved, and the lifetime of the filter media is extended.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method of regenerating filter media in a filter, comprising:
adding an alkali medicament into the filter;
introducing air into the filter; and
performing a reverse rinsing process to provide water from a bottom of the filter.

2. The method of claim 1, further comprising performing a draining process before adding the alkali medicament.

3. The method of claim 1, further comprising performing a sterilizing process.

4. The method of claim 3, wherein the sterilizing process is performed along with the reverse rinsing process to add sodium hypochlorite (NaOCl) into the filter.

5. The method of claim 3, wherein the sterilizing process is performed until a water solution in the filter has been adjusted to a neutral condition in the reverse rinsing process.

6. The method of claim 1, wherein the alkali medicament is added in accordance with water contained in the filter so as to maintain a pH value of a water solution in the filter between 8.5 and 11.

7. A method of regenerating filter media in a filter, the filter comprising a water solution and the filter media having a plurality of flocs including aluminum ions adhered thereto, the method comprising:
transforming the aluminum ions in the filter into complex ions carrying negative charges;
introducing air into the filter to break up the flocs; and
performing a reverse rinsing process to implant water from a bottom of the filter so that the flocs float up and are drained away from the filter.

8. The method of claim 7, wherein the aluminum ions are transformed into the complex ions by adding an alkali medicament.

9. The method of claim 8, wherein the alkali medicament is added in accordance with water contained in the filter so as to maintain an pH value of the water solution in the filter between 8.5 and 11.

10. The method of claim 8, further comprising performing a draining process before adding the alkali medicament so as to drain the water solution away from the filter until the water solution reaches a low level.

11. The method of claim 7, further comprising performing a sterilizing process.

12. The method of claim 11, wherein the sterilizing process is performed along with the reverse rinsing process to add sodium hypochlorite (NaOCl) into the filter.

13. The method of claim 12, wherein the sterilizing process is performed until the water solution in the filter has been adjusted to a neutral condition in the reverse rinsing process.
